(19) United States
(12) Patent Application Publication
(10) Pub. No.: US 2020/0411967 A1
(43) Pub. Date: Dec. 31, 2020

(54) ANTENNA, ANTENNA ARRAY AND BASE STATION

(71) Applicant: AAC Technologies Pte. Ltd., Singapore city (SG)

(72) Inventors: Jianchuan Liu, Shenzhen (CN); Yuehua Yue, Shenzhen (CN)

(21) Appl. No.: 16/994,659

(22) Filed: Aug. 17, 2020

Related U.S. Application Data
(63) Continuation of application No. PCT/CN2019/093952, filed on Jun. 29, 2019.

(51) Int. Cl. H01Q 1/24; H01Q 1/48; H01Q 9/04; H01Q 21/08

(52) U.S. Cl. CPC H01Q 1/246; H01Q 21/08; H01Q 9/0407; H01Q 1/48

(57) ABSTRACT

The present disclosure relates to the field of communication technology, in particular to an antenna, an antenna array and a base station. The antenna includes a conductive cover, a radiating portion and a feeding portion. The conductive cover is provided with an accommodating groove, the radiating portion and the feeding portion are respectively provided in the accommodating groove, the feeding portion is used to feed the radiating portion, and the feeding portion and the radiating portion are arranged at intervals. The antenna array includes at least one antenna described above. The base station includes the antenna array described above. The antenna, antenna array and base station of the present disclosure have advantages of good directivity of radiated electromagnetic waves and good isolation between the antenna and other components.

### TECHNICAL FIELD

The present disclosure relates to the field of communication technology, in particular to an antenna, an antenna array and a base station.

### BACKGROUND

The fifth-generation mobile communication technology will greatly change people's existing lifestyles and promote the continuous development of society. In order to adapt to technical characteristics such as high-speed, low-latency and high-capacity of future 5G, the base station antenna will also adopt more large-scale array antenna, and therefore higher requirements for the antenna are also proposed. The existing antenna has poor directivity, so that performance of receiving or transmitting signals is relatively poor.

Therefore, it is necessary to provide an antenna with good directivity to solve the above problems.

### SUMMARY

The present disclosure intends to provide an antenna, an antenna array and a base station with good directivity.

The technical solution of the present disclosure is as follows. The present disclosure provides an antenna; the antenna includes a conductive cover, a radiating portion and a feeding portion; the conductive cover is provided with an accommodating groove, the radiating portion and the feeding portion are respectively provided in the accommodating groove, the feeding portion is used to feed the radiating portion, and the feeding portion and the radiating portion are arranged at intervals.

As an improvement, the feeding portion is located between the radiating portion and a bottom of the accommodating groove, the feeding portion and the bottom of the accommodating groove are arranged at intervals to form an air cavity, the feeding portion is electrically connected to the conductive cover, and the feeding portion coupling feeds the radiating portion.

As an improvement, the feeding portion includes a feeding substrate and a first feeding line, a second feeding line and a first ground plate that are provided on the same surface of the feeding substrate; the first ground plate is provided with a first feeding slot and a second feeding slot that are perpendicular to each other; the first feeding line is electrically connected to the first ground plate at both ends of the first feeding slot respectively, the second feeding line is electrically connected to the first ground plate at both ends of the second feeding slot respectively, and the first ground plate is electrically connected to the conductive cover.

As an improvement, the first feeding line includes a first connection line, a second connection line and a third connection line; the first connection line is used to obtain an external signal, a first end of the second connection line is electrically connected to the first connection line, a second end of the second connection line is electrically connected to the first ground plate at one end of the first feeding slot, a first end of the third connection line is electrically connected to the first connection line, and a second end of the third connection line is electrically connected to the first ground plate at the other end of the first feeding slot.

The second feeding line includes a fourth connection line, a fifth connection line and a sixth connection line; the fourth connection line is used to obtain the external signal, a first end of the fifth connection line is electrically connected to the fourth connection line, a second end of the fifth connection line is electrically connected to the first ground plate at one end of the second feeding slot, a first end of the sixth connection line is electrically connected to the fourth connection line, and a second end of the sixth connection line is electrically connected to the first ground plate at the other end of the second feeding slot.

As an improvement, the first ground plate is further provided with two third feeding slots arranged at intervals and two fourth feeding slots arranged at intervals; the two third feeding slots are respectively perpendicular to the first feeding slot, the first feeding slot is located between the two third feeding slots, the first feeding slot is in communication with the two third feeding slots, the two fourth feeding slots are respectively perpendicular to the second feeding slot, the second feeding slot is located between the two fourth feeding slots, and the second feeding slot is in communication with the two fourth feeding slots.

As an improvement, the feeding portion further includes a second ground plate provided on a surface of the feeding substrate opposite to the first ground plate, the second ground plate is provided with a fifth feeding slot corresponding to the first feeding slot, and the second ground plate is further provided with a sixth feeding slot corresponding to the second feeding slot; the first ground plate is electrically connected to the second ground plate, and the first ground plate is electrically connected to the conductive cover.

As an improvement, the radiating portion includes a radiating patch, the feeding portion is provided between the radiating patch and a bottom of the accommodating groove, and a projection of the radiating patch on the first ground plate covers the first feeding slot and the second feeding slot.

As an improvement, the radiating portion includes a radiating substrate and a radiating patch disposed on a surface of the radiating substrate away from the feeding portion; the radiating patch is circular, square, octagonal or four-pointed star.

The present disclosure further provides an antenna array including 1×3 antennas described above.

The present disclosure further provides a base station including the antenna array described above.

Compared with the existing technology, the antenna provided in the embodiments of the present disclosure includes the conductive cover having the accommodating groove with an opening, the radiating portion disposed in the accommodating groove, and the feeding portion provided in the accommodating groove for feeding the radiating portion. The feeding portion and the radiating portion are arranged at intervals, the conductive cover makes the electromagnetic wave radiated by the radiating portion have good directivity and makes the antenna well isolated from other elements. The antenna of the present disclosure may be made into a standard part or a module used to, for example, form the antenna array of the present disclosure, which facilitates to quickly form an antenna base station.

### BRIEF DESCRIPTION OF THE DRAWINGS

FIG. 1 is a schematic diagram of a three-dimensional structure of an antenna provided in an embodiment of the present disclosure;

FIG. 2 is a schematic diagram of an exploded structure of an antenna provided in an embodiment of the present disclosure;

FIG. 3 is a schematic diagram of a three-dimensional structure of a conductive cover provided in an embodiment of the present disclosure;

FIG. 4A is a schematic diagram of an exploded structure of a feeding portion provided in an embodiment of the present disclosure;

FIG. 4B is a sectional structural view along A-A in FIG. 1;

FIG. 5 is a schematic structural diagram of a first ground plate, a first feeding line and a second feeding line provided in an embodiment of the present disclosure;

FIG. 6 is an enlarged structural schematic view of A in FIG. 4;

FIG. 7 is an enlarged structural schematic view of B in FIG. 4;

FIG. 8 is a schematic structural diagram of a second ground plate provided in an embodiment of the present disclosure;

FIG. 9 is an exploded structural view of a radiating portion provided by an embodiment of the present disclosure;

FIG. 10 is an isolation of an antenna in the manner provided in an embodiment of the present application;

FIG. 11 is a schematic structural diagram of an antenna array provided by an embodiment of the present disclosure.

### DETAILED DESCRIPTION

In order to make objectives, technical solutions and advantages of the present disclosure clearer, the present disclosure will be explained below in detail with reference to the accompanying drawings and embodiments. It should be understood that the specific embodiments described here only used to explain but not to limit the present disclosure. Based on the embodiments of the present disclosure, all other embodiments obtained by those of ordinary skills in the art without making any inventive efforts fall within the protection scope of the present disclosure.

The terms “first”, “second”, “third”, “fourth”, etc. (if any) in the description, claims and the above drawings of the present disclosure are used to distinguish similar objects without being used to describe a specific order or sequence. It should be understood that the data used in this way may be interchanged under appropriate circumstances so that the embodiments described herein may be implemented in an order other than what is illustrated or described herein. In addition, the terms “including” and “having” and any variations thereof are intended to cover non-exclusive inclusions, for example, processes, methods, systems, products or devices that include a series of steps or units need not be limited to those steps or units clearly listed but may include other steps or units that are not explicitly listed or inherent to these processes, methods, products or devices.

It should be noted that the descriptions related to “first”, “second”, etc. in the present disclosure are only for the purpose of description, and may not be understood as indicating or implying their relative importance or implicitly indicating the number of technical features indicated. Thus, the features defined as “first” and “second” may include at least one of the features either explicitly or implicitly. In addition, the technical solutions between the various embodiments may be combined with each other, but they must be based on the premise that those of ordinary skills in the art are able to achieve. When the combination of technical solutions conflicts with each other or may not be realized, it should be considered that the combination of such technical solutions does not exist and is not within the protection scope claimed by the present disclosure.

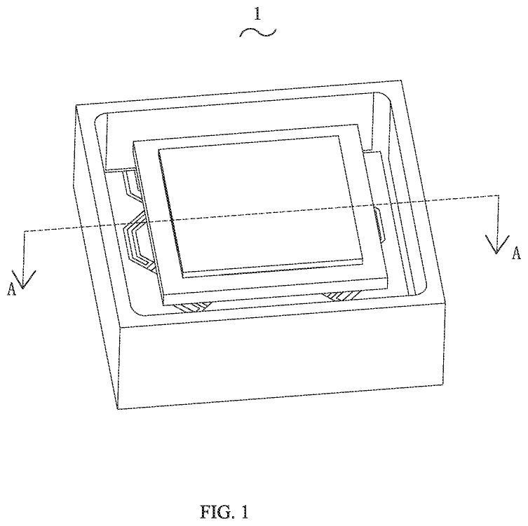

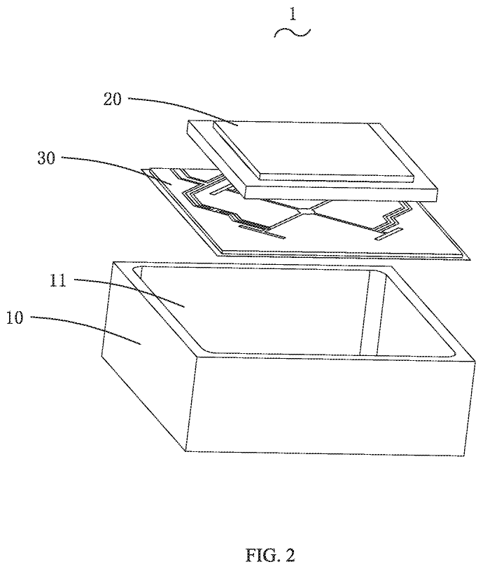

Referring to FIG. 1 and FIG. 2, the present disclosure provides an antenna 1 which may achieve dual polarization. The antenna 1 includes a conductive cover 10, a radiating portion 20 and a feeding portion 30. The conductive cover 10 is provided with an accommodating groove 11, the radiating portion 20 and the feeding portion 30 are respectively provided in the accommodating groove 11, the feeding portion 30 is used to feed the radiating portion 20, and the feeding portion 30 and the radiating portion 20 are arranged at intervals. The radiating portion 20 and the feeding portion 30 are fixedly connected to the conductive cover 10 respectively, and the feeding portion 30 is closer to a bottom of the accommodating groove 11 than the radiating portion 20. The feeding portion 30 feeds the radiating portion 20, the radiating portion 20 radiates electromagnetic waves, the conductive cover 10 makes the electromagnetic waves radiated by the radiating portion 20 have good directivity and makes the antenna 1 well isolated from other components.

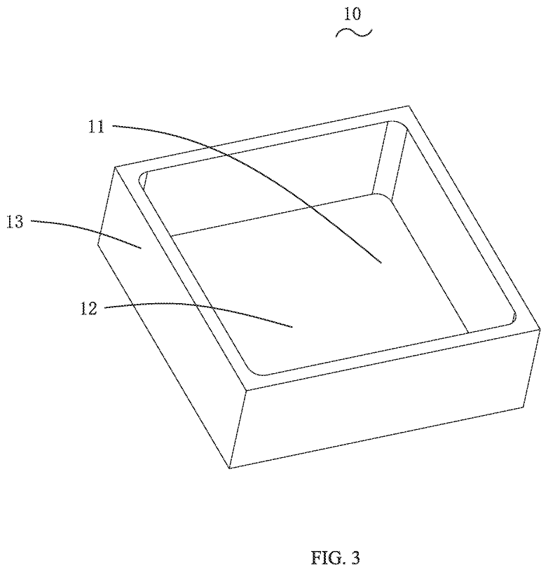

Referring to FIG. 3, the conductive cover 10 includes a bottom plate 12 and four side plates 13 extending upward from the bottom plate 12. The bottom plate 12 and the four side plates 13 surround an accommodating groove 11 with an opening (not labeled). The bottom plate 12 is the bottom of the accommodating groove 11, and the side plates 13 are side walls of the accommodating groove 11. A shape of the conductive cover 10 is a cube or cuboid. In this embodiment, the shape of the conductive cover 10 is a cube. A material of the conductive cover 10 is a conductive material, preferably a conductive metal or alloy. The material of the conductive cover 10 includes but is not limited to copper, aluminum and silver. The conductive cover 10 may be manufactured by a stamping process, a die-casting process or a plastic electroplating process.

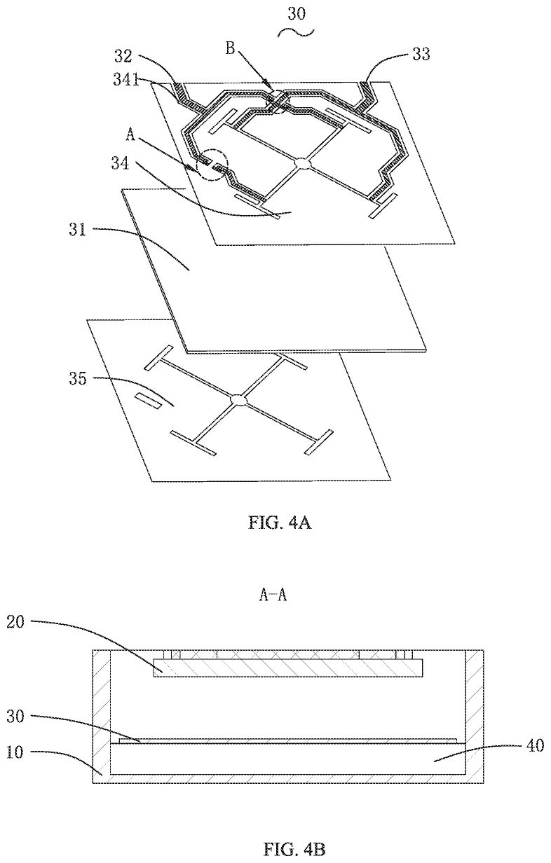

Referring to FIG. 4A and FIG. 4B, the feeding portion 30 and the bottom of the accommodating groove 11 are arranged at intervals to form an air cavity 40, so that the feeding portion 30 may better coupling feed the radiating portion 20. The radiating portion 20 is electrically connected to the conductive cover 10, and the feeding portion 30 coupling feeds the radiating portion 20. The feeding portion 30 includes a feeding substrate 31, and a first feeding line 32, a second feeding line 33 and a first ground plate 34 that are provided on the same surface of the feeding substrate 31, and a second ground plate 35 provided on a surface of the feeding substrate 31 opposite to the first ground plate 34. The first ground plate 34 is provided on a surface of the feeding substrate 31 adjacent to the radiating portion 20, and the second ground plate 35 is provided on a surface of the feeding substrate 31 adjacent to the bottom plate 12. An air gap is included between the second ground plate 35 and the bottom of the accommodating groove 11 to form the air cavity 40. The first feeding line 32 and the second feeding line 33 are electrically connected to the first ground plate 34 respectively. The first ground plate 34 and the second ground plate 35 coupling feed the radiating portion 20.

The shape of the feeding substrate 31 conforms to the shape of the bottom plate 12 of the conductive cover 10. The feeding substrate 31 and the side plates 13 of the conductive cover 10 are fixedly connected, and the feeding substrate 31 and the bottom plate 12 of the conductive cover 10 are arranged at intervals, which makes the second ground plate 35 and the bottom plate 12 arranged at intervals.

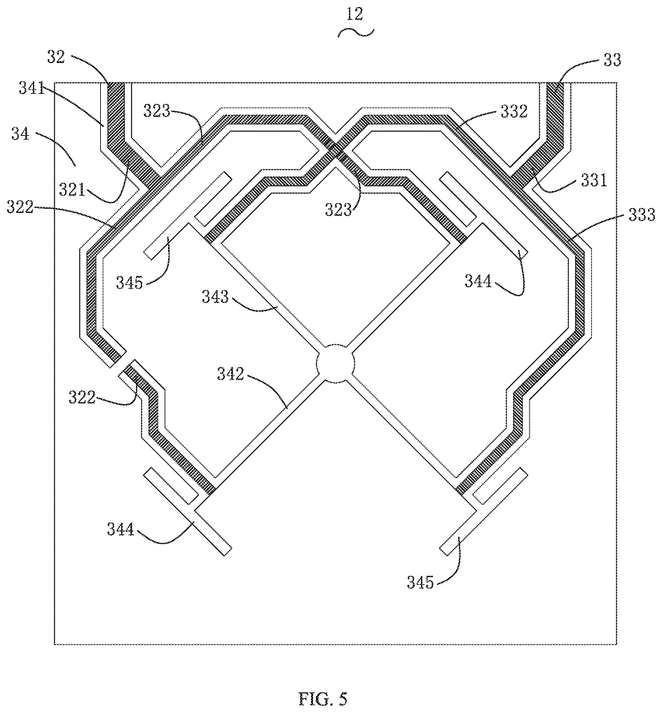

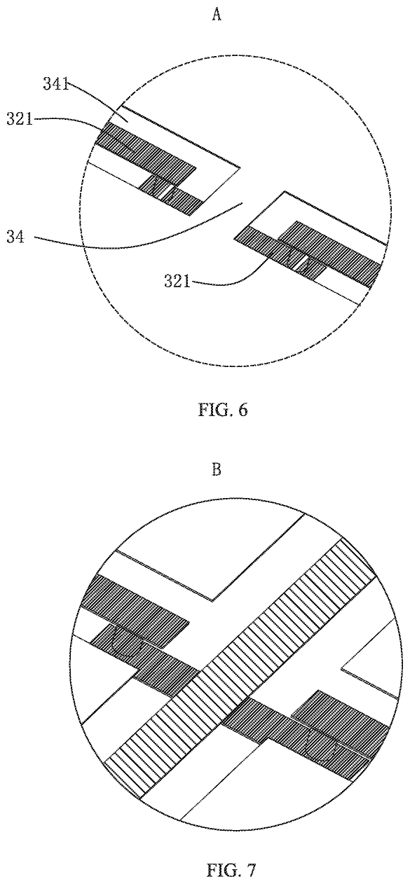

Referring to FIG. 5, FIG. 6 and FIG. 7, the first ground plate 34 is electrically connected to the conductive cover 10. The first ground plate 34 is provided with a avoiding slot 341 which is used to leave space for the first feeding line 32 and the second feeding line 33, so that the first feeding line 32 and the second feeding line 33 may be arranged on the feeding substrate 31. The shape of the avoiding slot 341 is not limited, and may be set according to the shapes of the first feeding line 32 and the second feeding line 33.

The first ground plate 34 is further provided with a first feeding slot 342 and a second feeding slot 343 that are perpendicular to each other. The first feeding slot 342 intersects with the second feeding slot 343. The first feeding line 32 is electrically connected to the first ground plate 34 at both ends of the first feeding slot 342 respectively, and the second feeding line 33 is electrically connected to the first ground plate 34 at both ends of the second feeding slot 343 respectively. The first feeding slot 342 and the second feeding slot 343 are provided on the first ground plate 34, so the first feeding line 32 may be connected to the first ground plate 34 near both ends of the first feeding slot 342, and the second feeding line 33 may be connected to the first ground plate 34 near both ends of the second feeding slot 343. A length and width of the first feeding slot 342 and the second feeding slot 343 may be set as required, which is not limited in this embodiment. The first feeding slot 342 and the second feeding slot 343 feed the radiating portion 20. Since the first feeding slot 342 are perpendicular to the second feeding slot 343, the antenna 1 of the present disclosure is a dual-polarized antenna.

The first ground plate 34 is further provided with two third feeding slots 344 arranged at intervals and two fourth feeding slots 345 arranged at intervals. The two third feeding slots 344 are respectively perpendicular to the first feeding slot 342, and the first feeding slot 342 is located between the two third feeding slots 344. The two fourth feeding slots 345 are respectively perpendicular to the second feeding slot 343, and the second feeding slot 343 is located between the two fourth feeding slots 345. The first feeding slot 342, the second feeding slot 343, the third feeding slot 344 and the fourth feeding slot 345 on the first ground plate 34 feed the radiating portion 20. The third feeding slot 344 and the fourth feeding slot 345 may reduce the size of the antenna 1 when making the antenna 1 have the same radiation effect. In this embodiment, the avoiding slot 341, the first feeding slot 342 and the third feeding slot 344 are communicated. The avoiding slot 341, the second feeding slot 343 and the fourth feeding slot 345 are communicated.

The first feeding line 32 includes a microstrip line or a strip line. The first feeding line 32 may be a Coplanar Waveguide (CPWG) line. The first feeding line 32 includes a first connection line 321, a second connection line 322 and a third connection line 323. The first connection line 321 is used to electrically connect with the external to obtain external signals. A first end of the second connection line 322 is electrically connected to the first connection line 321, and a second end of the second connection line 322 is electrically connected to the first ground plate 34 at one end of the first feeding slot 342. A first end of the third connection line 323 is electrically connected to the first connection line 321, and a second end of the third connection line 323 is electrically connected to the first ground plate 34 at the other end of the first feeding slot 342. The shapes of the first connection line 321, the second connection line 322 and the third connection line 323 on the feeding substrate 31 are not limited, as long as the connection relationship with the first feeding slot 342 may be achieved. In this embodiment, the second connection line 322 includes two sections, a connection between a first section of the second connection line 322 and a second section of the second connection line 322 bypasses part of the first ground plate 34, and the second section of the second connection line 322 is electrically connected to the first ground plate 34 at one end of the first feeding slot 342. When the second connection line 322 bypasses part of the first ground plate 34, the second connection line 322 may pass through the feeding substrate 31. The second connection line 322 includes the two sections to reduce the reflection of the resistance signal. The third connection line 323 includes two sections, a connection between a first section of the third connection line 323 and a second section of the third connection line 323 bypasses the second feeding line 33, and the second section of the third connection line 323 is electrically connected to the first ground plate 34 at the other end of the feeding slot 342. When the third connection line 323 bypasses the second feeding line 33, the third connection line 323 may pass through the feeding substrate 31.

The second feeding line 33 includes the microstrip line or the strip line. Phases of the signals acquired by the second feeding line 33 and the first feeding line 32 are equal. The second feeding line 33 may be the Coplanar Waveguide (CPWG) line. The second feeding line 33 includes a fourth connection line 331, a fifth connection line 332 and a sixth connection line 333. The fourth connection line 331 is used to electrically connect with the external to obtain external signals. A first end of the fifth connection line 332 is electrically connected to the fourth connection line 331, and a second end of the fifth connection line 332 is electrically connected to the first ground plate 34 at one end of the second feeding slot 343. A first end of the sixth connection line 333 is electrically connected to the fourth connection lines 331, and a second end of the sixth connection line 333 is electrically connected to the first ground plate 34 at the other end of the second feeding slot 343. The shapes of the fourth connection line 331, the fifth connection line 332 and the sixth connection line 333 on the feeding substrate 31 are not limited, as long as the connection relationship with the second feeding slot 343 may be achieved.

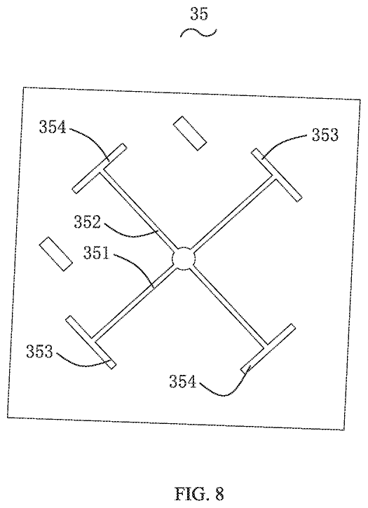

Referring to FIG. 8, the second ground plate 35 is provided with a fifth feeding slot 351 corresponding to the first feeding slot 342, a sixth feeding slot 352 corresponding to the second feeding slot 343, two seventh feeding slots 353 corresponding to two third feeding slots 344, and two eighth feeding slots 354 corresponding to two fourth feeding slots 345. The fifth feeding slot 351, the sixth feeding slot 352, the seventh feeding slot 353 and the eighth feeding slot 354 may also feed the radiating portion 20. The second ground plate 35 is electrically connected to the first ground plate 34, and the first ground plate 34 is electrically connected to the conductive cover 10, thereby realizing the electrical connection between the second ground plate 35 and the conductive cover 10. The electrical connection between the first ground plate 34 and the conductive cover 10 may be realized by fixing the radiating portion 20 through metal screws.

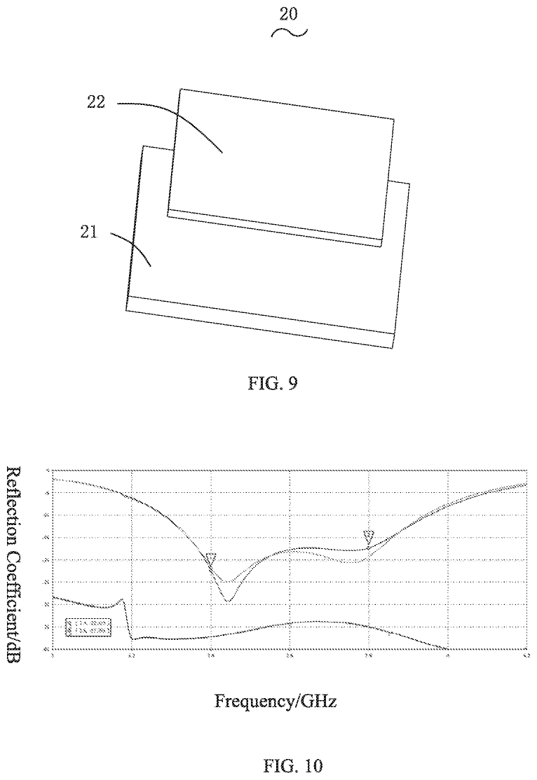

Referring to FIG. 9, the radiating portion 20 includes a bracket 21 and a radiating patch 22 disposed on a surface of the bracket 21 away from the feeding portion 30. The feeding portion 30 is closer to the bottom plate 12 at the bottom of the accommodating groove 11 than the radiating patch 22 of the radiating portion 20.

The bracket 21 is used to support the radiating patch 22, fix the radiating patch 22 on the conductive cover, and make the radiating patch 22 and the first ground plate 34 of the feeding portion 30 arranged at intervals, that is, the bracket 21 makes a gap between the radiating patch 22 and the feeding portion 30, and the gap is filled with air. The bracket 21 and the side plates 13 are fixedly connected. The manner in which the bracket 21 and the side plates 13 are fixedly connected is not limited.

The shape of the radiating patch 22 is not limited. The shape of the radiating patch 22 includes, but is not limited to, a circle, a square, an octagon and a four-pointed star. Preferably, a projection of the radiating patch 22 on the first ground plate 34 covers the first feeding slot 342, the second feeding slot 343, the third feeding slot 344 and the fourth feeding slot 345, which makes the feeding effects better.

The performance of the antenna 1 described above is shown in FIG. 10, and it can be seen from the figure that the antenna 1 may cover 3.4˜3.8 GHz frequency band and has a relatively high gain.

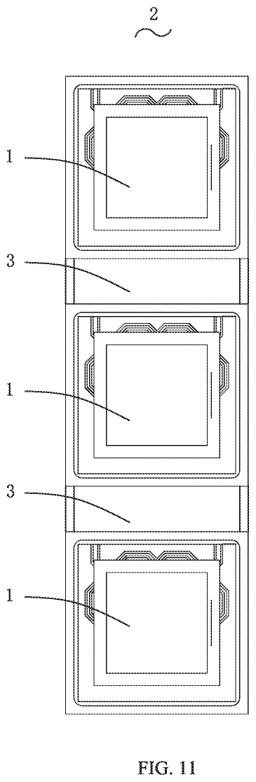

Referring to FIG. 11, the present disclosure further provides an antenna array 2. The antenna array 2 includes at least one antenna 1 described above. In an embodiment, the antenna array 2 includes 1×2 or 1×3 antennas 1. In this embodiment, the antenna array 2 further includes an isolation band 3 when including at least two antennas 1. The antenna 1 is connected to an adjacent antenna 1 through the isolation band 3. The first ground plates 34 of the feeding portions 30 of two adjacent antennas 1 are electrically connected to the isolation band 3 respectively, that is, the first ground plate 34 of one antenna 1 are electrically connected to the first ground plate 34 of the adjacent antenna 1 through the isolation band 3.

The present disclosure further provides a base station including the antenna array described above.

The above description are only embodiments of the present disclosure. It should be noted that those of ordinary skills in the art may make improvements without departing from the inventive concept of the present disclosure, however, these improvements belong to the protection scope of the present disclosure.

What is claimed is:

1. An antenna, comprising a conductive cover, a radiating portion and a feeding portion, wherein the conductive cover is provided with an accommodating groove, the radiating portion and the feeding portion are respectively provided in the accommodating groove, the feeding portion is used to feed the radiating portion, and the feeding portion and the radiating portion are arranged at intervals.

2. The antenna according to claim 1, wherein the feeding portion is located between the radiating portion and a bottom of the accommodating groove, the feeding portion and the bottom of the accommodating groove are arranged at intervals to form an air cavity, the feeding portion is electrically connected to the conductive cover, and the feeding portion coupling feeds the radiating portion.

3. The antenna according to claim 1, wherein the feeding portion comprises a feeding substrate and a first feeding line, a second feeding line and a first ground plate that are provided on the same surface of the feeding substrate, the first ground plate is provided with a first feeding slot and a second feeding slot that are perpendicular to each other, the first feeding line is electrically connected to the first ground plate at both ends of the first feeding slot respectively, the second feeding line is electrically connected to the first ground plate at both ends of the second feeding slot respectively, and the first ground plate is electrically connected to the conductive cover.

4. The antenna according to claim 3, wherein the first feeding line comprises a first connection line, a second connection line and a third connection line, the first connection line is used to obtain an external signal, a first end of the second connection line is electrically connected to the first connection line, a second end of the second connection line is electrically connected to the first ground plate at one end of the first feeding slot, a first end of the third connection line is electrically connected to the first connection line, and a second end of the third connection line is electrically connected to the first ground plate at the other end of the first feeding slot;
the second feeding line comprises a fourth connection line, a fifth connection line and a sixth connection line, the fourth connection line is used to obtain the external signal, a first end of the fifth connection line is electrically connected to the fourth connection line, a second end of the fifth connection line is electrically connected to the first ground plate at one end of the second feeding slot, a first end of the sixth connection line is electrically connected to the fourth connection line, and a second end of the sixth connection line is electrically connected to the first ground plate at the other end of the second feeding slot.

5. The antenna according to claim 3, wherein the first ground plate is further provided with two third feeding slots arranged at intervals and two fourth feeding slots arranged at intervals, the two third feeding slots are respectively perpendicular to the first feeding slot, the first feeding slot is located between the two third feeding slots, the first feeding slot is in communication with the two third feeding slots, the two fourth feeding slots are respectively perpendicular to the second feeding slot, the second feeding slot is located between the two fourth feeding slots, and the second feeding slot is in communication with the two fourth feeding slots.

6. The antenna according to claim 3, wherein the feeding portion further comprises a second ground plate provided on a surface of the feeding substrate opposite to the first ground plate, the second ground plate is provided with a fifth feeding slot corresponding to the first feeding slot, and the second ground plate is further provided with a sixth feeding slot corresponding to the second feeding slot; the first ground plate is electrically connected to the second ground plate, and the first ground plate is electrically connected to the conductive cover.

7. The antenna according to claim 3, wherein the radiating portion comprises a radiating patch, the feeding portion is provided between the radiating patch and a bottom of the accommodating groove, and a projection of the radiating patch on the first ground plate covers the first feeding slot and the second feeding slot.

8. The antenna according to claim 1, wherein the radiating portion comprises a radiating substrate and a radiating patch disposed on a surface of the radiating substrate away from the feeding portion, and the radiating patch is circular, square, octagonal or four-pointed star.

9. An antenna array, comprising 1×3 antennas; wherein the antenna comprises a conductive cover, a radiating portion and a feeding portion; wherein the conductive cover is provided with an accommodating groove, the radiating portion and the feeding portion are respectively provided in the accommodating groove, the feeding portion is used to feed the radiating portion, and the feeding portion and the radiating portion are arranged at intervals.

10. The antenna array according to claim 9, wherein the feeding portion is located between the radiating portion and a bottom of the accommodating groove, the feeding portion and the bottom of the accommodating groove are arranged at intervals to form an air cavity, the feeding portion is electrically connected to the conductive cover, and the feeding portion coupling feeds the radiating portion.

11. The antenna array according to claim 9, wherein the feeding portion comprises a feeding substrate and a first feeding line, a second feeding line and a first ground plate that are provided on the same surface of the feeding substrate, the first ground plate is provided with a first feeding slot and a second feeding slot that are perpendicular to each other, the first feeding line is electrically connected to the first ground plate at both ends of the first feeding slot respectively, the second feeding line is electrically connected to the first ground plate at both ends of the second feeding slot respectively, and the first ground plate is electrically connected to the conductive cover.

12. The antenna array according to claim 11, wherein the first feeding line comprises a first connection line, a second connection line and a third connection line, the first connection line is used to obtain an external signal, a first end of the second connection line is electrically connected to the first connection line, a second end of the second connection line is electrically connected to the first ground plate at one end of the first feeding slot, a first end of the third connection line is electrically connected to the first connection line, and a second end of the third connection line is electrically connected to the first ground plate at the other end of the first feeding slot;
the second feeding line comprises a fourth connection line, a fifth connection line and a sixth connection line, the fourth connection line is used to obtain the external signal, a first end of the fifth connection line is electrically connected to the fourth connection line, a second end of the fifth connection line is electrically connected to the first ground plate at one end of the second feeding slot, a first end of the sixth connection line is electrically connected to the fourth connection line, and a second end of the sixth connection line is electrically connected to the first ground plate at the other end of the second feeding slot.

13. The antenna array according to claim 11, wherein the first ground plate is further provided with two third feeding slots arranged at intervals and two fourth feeding slots arranged at intervals, the two third feeding slots are respectively perpendicular to the first feeding slot, the first feeding slot is located between the two third feeding slots, the first feeding slot is in communication with the two third feeding slots, the two fourth feeding slots are respectively perpendicular to the second feeding slot, the second feeding slot is located between the two fourth feeding slots, and the second feeding slot is in communication with the two fourth feeding slots.

14. The antenna array according to claim 11, wherein the feeding portion further comprises a second ground plate provided on a surface of the feeding substrate opposite to the first ground plate, the second ground plate is provided with a fifth feeding slot corresponding to the first feeding slot, and the second ground plate is further provided with a sixth feeding slot corresponding to the second feeding slot; the first ground plate is electrically connected to the second ground plate, and the first ground plate is electrically connected to the conductive cover.

15. The antenna array according to claim 11, wherein the radiating portion comprises a radiating patch, the feeding portion is provided between the radiating patch and a bottom of the accommodating groove, and a projection of the radiating patch on the first ground plate covers the first feeding slot and the second feeding slot.

16. The antenna array according to claim 9, wherein the radiating portion comprises a radiating substrate and a radiating patch disposed on a surface of the radiating substrate away from the feeding portion, and the radiating patch is circular, square, octagonal or four-pointed star.

17. A base station, comprising an antenna array; wherein the antenna array comprises 1×3 antennas, and the antenna comprises a conductive cover, a radiating portion and a feeding portion; wherein the conductive cover is provided with an accommodating groove, the radiating portion and the feeding portion are respectively provided in the accommodating groove, the feeding portion is used to feed the radiating portion, and the feeding portion and the radiating portion are arranged at intervals.

18. The base station according to claim 17, wherein the feeding portion is located between the radiating portion and a bottom of the accommodating groove, the feeding portion and the bottom of the accommodating groove are arranged at intervals to form an air cavity, the feeding portion is electrically connected to the conductive cover, and the feeding portion coupling feeds the radiating portion.

19. The base station according to claim 17, wherein the feeding portion comprises a feeding substrate and a first feeding line, a second feeding line and a first ground plate that are provided on the same surface of the feeding substrate, the first ground plate is provided with a first feeding slot and a second feeding slot that are perpendicular to each other, the first feeding line is electrically connected to the first ground plate at both ends of the first feeding slot respectively, the second feeding line is electrically connected to the first ground plate at both ends of the second feeding slot respectively, and the first ground plate is electrically connected to the conductive cover.

20. The base station according to claim 19, wherein the first feeding line comprises a first connection line, a second connection line and a third connection line, the first connection line is used to obtain an external signal, a first end of the second connection line is electrically connected to the first connection line, a second end of the second connection line is electrically connected to the first ground plate at one end of the first feeding slot, a first end of the third connection line is electrically connected to the first connection line, and a second end of the third connection line is electrically connected to the first ground plate at the other end of the first feeding slot;
the second feeding line comprises a fourth connection line, a fifth connection line and a sixth connection line, the fourth connection line is used to obtain the external signal, a first end of the fifth connection line is electrically connected to the fourth connection line, a second end of the fifth connection line is electrically connected to the first ground plate at one end of the second feeding slot, a first end of the sixth connection line is electrically connected to the fourth connection line, and a second end of the sixth connection line is electrically connected to the first ground plate at the other end of the second feeding slot.
